(19) United States
(12) Patent Application Publication
(10) Pub. No.: US 2025/0317939 A1
(43) Pub. Date: Oct. 9, 2025

(54) ON-DEMAND SIB1 TRANSMISSION

(71) Applicant: Lenovo (Singapore) Pte. Limited, Singapore (SG)

(72) Inventors: Alexander Golitschek Edler von Elbwart, Darmstadt (DE); Joachim Löhr, Wiesbaden (DE); Prateek Basu Mallick, Dreieich (DE)

(73) Assignee: Lenovo (Singapore) Pte. Limited, Singapore (SG)

(21) Appl. No.: 19/084,710

(22) Filed: Mar. 19, 2025

Related U.S. Application Data
(60) Provisional application No. 63/574,220, filed on Apr. 3, 2024.

(51) Int. Cl. H04W 72/231; H04L 5/00; H04W 72/1273

(52) U.S. Cl. CPC H04W 72/231; H04L 5/0053; H04W 72/1273

(57) ABSTRACT

Various aspects of the present disclosure relate to on-demand system information block 1 (SIB1) transmission. An apparatus, such as a user equipment (UE), transmits, to a network equipment (NE), a request for one or more SIB1 transmissions. The UE receives, from the NE, a first downlink control information (DCI) in a format scrambled with a radio network temporary identifier (RNTI), where the first DCI is determinable by the UE as an acknowledgement. An NE receives, from a UE, a request for one or more SIB1 transmissions. The NE transmits, to the UE, a first DCI in a format scrambled with a RNTI, where the first DCI is determinable by the UE as an acknowledgement.

### RELATED APPLICATION

This application claims priority to U.S. Provisional Application Ser. No. 63/574,220 filed Apr. 3, 2024 entitled “On-Demand SIB1 Transmission,” the disclosure of which is incorporated by reference herein in its entirety.

### TECHNICAL FIELD

The present disclosure relates to wireless communications, and more specifically to user equipment (UE) and network equipment (NE) signaling.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system may support wireless communications, and may include one or more devices, such as UEs, base stations, network entities, satellites, and/or network equipment (NE), among other devices, that transmit and/or receive signaling. The wireless communications signaling between UEs and NEs (e.g., base stations, gNBs) may be considered for overall network energy savings.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A UE for wireless communication is described. The UE may be configured to, capable of, or operable to perform one or more operations as described herein. For example, the UE may be configured to, capable of, or operable to transmit, to a NE, a request for one or more system information block 1 (SIB1) transmissions. The UE receives, from the NE, a first downlink control information (DCI) in a format scrambled with a radio network temporary identifier (RNTI), where the first DCI is determinable by the UE as an acknowledgement.

A processor (e.g., a standalone processor chipset, or a component of a UE) for wireless communication is described. The processor may be configured to, capable of, or operable to perform one or more operations as described herein. For example, the processor may be configured to, capable of, or operable to transmit, to a NE, a request for one or more SIB1 transmissions; and receive, from the NE, a first DCI in a format scrambled with a RNTI, where the first DCI is determinable by the UE as an acknowledgement.

A method performed or performable by a UE for wireless communication is described. The method may include transmitting, to a NE, a request for one or more SIB1 transmissions; and receiving, from the NE, a first DCI in a format scrambled with a RNTI, the first DCI being determinable by the UE as an acknowledgement.

In some implementations of the UE, the processor, and the method described herein, the UE, the processor, and the method may be configured to, capable of, or operable to stop a SIB1 transmission request procedure based on the first DCI in the format scrambled with the RNTI determined as the acknowledgement. In some implementations of the UE, the processor, and the method described herein, the RNTI is at least one of a random access (RA)-RNTI, a message B (MsgB)-RNTI, a system information (SI)-RNTI, or a SIB1-RNTI. In some implementations of the UE, the processor, and the method described herein, the UE, the processor, and the method may be configured to, capable of, or operable to detect a SIB1 transmission based on detection of the first DCI. To detect the SIB1 transmission, the format scrambled with a SI-RNTI configures the UE to detect a second DCI. The SIB1 transmission is scheduled according to the first DCI. The SIB1 transmission is scheduled according to a physical downlink shared channel (PDSCH) that is scheduled by the first DCI. In some implementations of the UE, the processor, and the method described herein, the UE, the processor, and the method may be configured to, capable of, or operable to restart a SIB1 transmission request procedure based on the UE does not detect the first DCI as the acknowledgement.

An NE (e.g., a base station) for wireless communication is described. The NE may be configured to, capable of, or operable to perform one or more operations as described herein. For example, the NE may be configured to, capable of, or operable to receive, from a UE, a request for one or more SIB1 transmissions. The NE transmits, to the UE, a first DCI in a format scrambled with a RNTI, the first DCI being determinable by the UE as an acknowledgement.

A processor (e.g., a standalone processor chipset, or a component of a NE) for wireless communication is described. The processor may be configured to, capable of, or operable to perform one or more operations as described herein. For example, the processor may be configured to, capable of, or operable to receive, from a UE, a request for one or more SIB1 transmissions; and transmit, to the UE, a first DCI in a format scrambled with a RNTI, the first DCI being determinable by the UE as an acknowledgement.

A method performed or performable by an NE (e.g., a base station) for wireless communication is described. The method may include receiving, from a UE, a request for one or more SIB1 transmissions; and transmitting, to the UE, a first DCI in a format scrambled with a RNTI, the first DCI being determinable by the UE as an acknowledgement.

In some implementations of the NE, the processor, and the method described herein, the RNTI is at least one of a RA-RNTI, a MsgB-RNTI, a SI-RNTI, or a SIB1-RNTI. The NE receives an additional request for the one or more SIB1 transmissions based on the UE does not detect the first DCI as the acknowledgement.

### BRIEF DESCRIPTION OF THE DRAWINGS

FIG. 1 illustrates an example of a wireless communications system in accordance with aspects of the present disclosure.

FIG. 2 illustrates an example signaling diagram and procedures for 5G random access channel (RACH), in accordance with aspects of the present disclosure.

FIG. 3 illustrates an example signaling diagram for master information block (MIB) and system information block (SIB) signaling between a UE and NE, in accordance with aspects of the present disclosure.

FIGS. 4a-c illustrate an example of SIB1 message configuration information, in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of a network equipment (NE) in accordance with aspects of the present disclosure.

FIG. 8 illustrates a flowchart of a method performed by a UE in accordance with aspects of the present disclosure.

FIG. 9 illustrates a flowchart of a method performed by an NE in accordance with aspects of the present disclosure.

### DETAILED DESCRIPTION

A wireless communications system may support wireless communications for one or more devices, such as UEs, base stations, network entities, satellites, and/or other devices, supporting wireless communications (e.g., control information, data, packets, etc.). The wireless communications system may consume substantial power or energy as a result of the various signaling aspects associated with the wireless communications between the various devices (e.g., UEs, base stations, network entities, satellites, and/or other devices). For example, one or more of the base stations or the network entities may consume power or energy to transmit one or more synchronization signal blocks (SSBs), including physical broadcast channel (PBCH) for MIB and system information block 1 (SIB1) transmissions. Providing SIB1 transmissions on an on-demand basis reduces network traffic and saves energy. For example, a serving cell may not broadcast SIB1 for network energy savings, and instead, a UE can explicitly request (e.g., on-demand) the SIB1.

The power or energy consumption by the various devices (e.g., UEs, base stations, network entities, satellites, and/or other devices) may be adversely impacting the environment and the climate. Additionally, the power or energy consumption by the various devices (e.g., UEs, base stations, network entities, satellites, and/or other devices) may result in high operating expenses for consumers and operators associated with the wireless communications system. The continued expansion of data traffic, combined with the rising costs of spectrum, capital investment, and ongoing radio access network (RAN) maintenance and upgrades, necessitates energy-saving measures in network operations. The 5G New Radio (NR) offers significant energy-efficiency improvements per gigabyte over previous generations of data mobility. However, new 5G use cases and the adoption of mmWave may likely require additional RAN sites and antennas. This prospect could lead to the development of a more efficient network, but may also result in higher emissions and increased operating expenses. As 5G and radio access technologies beyond 5G become more prevalent across industries and geographical areas, the demand for advanced services and applications with higher data rates grow. Accordingly, networks may have to utilize more antennas, larger bandwidths, and a greater number of frequency bands compared to other radio access technologies (e.g., 4G).

Aspects of the disclosure include using DCI scrambled with RA-RNTI or MsgB-RNTI, and frequency domain resource allocation (FDRA) to indicate SIB1 transmission request acknowledgement. Aspects of the described techniques include a random access preamble identifier (RAPID) or a requested cell identifier (ID) in the acknowledgement message for contention resolution. The described techniques also include indicating SIB1 transmission in DCI that indicates acknowledgement, and defining a new RNTI and DCI fields for DCI indicating acknowledgement for the SIB1 transmission request. By utilizing the described techniques, a UE operating in an idle mode can obtain SIB1 transmissions from a gNB after having sent a request, and gNB can convey acknowledgement of the requested SIB1 transmissions after having received the SIB1 request from the UE.

Aspects of the present disclosure are described in the context of a wireless communications system. In the wireless communications system, a UE and an NE (e.g., a base station, gNB, network entity, network node) may support wireless communication, including reception and/or transmission of wireless communication using time-frequency resources. For example, the UE and the NE may support communicating signals (e.g., carrying control information, data, or the like). It should be understood that various terms may be used interchangeably with “communicating,” such as “signaling,” “transmitting,” “receiving,” “outputting,” “forwarding,” “relaying,” “retrieving,” “obtaining,” and so forth.

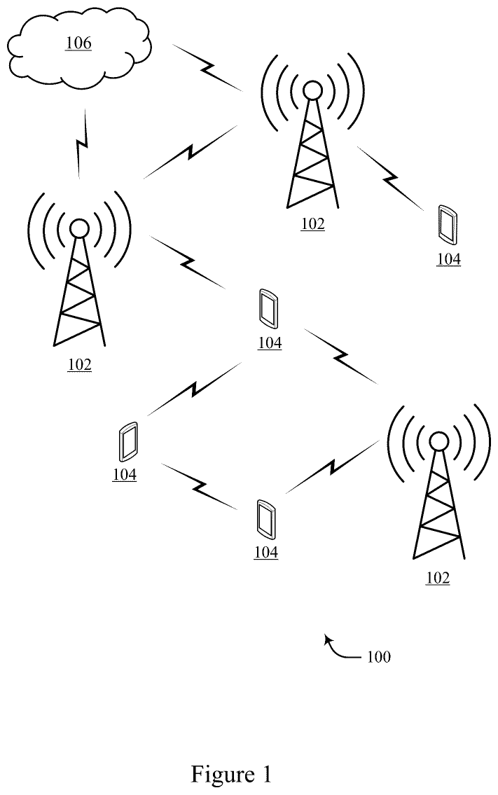

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a network node, network infrastructure, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, fifth, sixth, and seventh numerologies (i.e., μ=0, μ=1, μ=2, μ=3, μ=4, μ=5, μ=6) associated with respective subcarrier spacings of 15 kHz, 30 kHz, 60 kHz, 120 kHz, 240 kHz, 480 kHz, and 960 kHz may utilize a single slot per subframe, two slots per subframe, four slots per subframe, eight slots per subframe, 16 slots per subframe, 32 slots per subframe, and 64 slots per subframe, respectively. #Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations frequency range 1 (FR1) (410 MHz-7.125 GHz), and frequency range 2 (FR2) (24.25 GHz-71 GHz). In some implementations, the NEs 102 and the UEs 104 may perform wireless communications over one or more of the operating frequency bands. In some implementations, FRI may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 transmits, to an NE 102, a request for one or more SIB1 transmissions. The UE 104 receives, from the NE 102, a first DCI in a format scrambled with a RNTI, where the first DCI is determinable by the UE as an acknowledgement. In another example, an NE 102 receives, from a UE 104, a request for one or more SIB1 transmissions. The NE 102 transmits, to the UE 104, a first DCI in a format scrambled with a RNTI, where the first DCI is determinable by the UE as an acknowledgement.

With reference to network energy savings, emissions and energy consumption by the many various network devices and entities in a wireless communications system may be adversely contributing to the climate, not to mention the extensive operating expenses to run telecommunication devices and services. The continued expansion of data traffic, combined with the rising costs of spectrum, capital investment, and ongoing radio access network (RAN) maintenance and upgrades, necessitates energy-saving measures in network operations. The 5G New Radio (NR) offers significant energy-efficiency improvements per gigabyte over previous generations of data mobility. However, new 5G use cases and the adoption of mmWave may likely require additional RAN sites and antennas. This prospect could lead to the development of a more efficient network, but may also result in higher emissions and increased operating expenses. As 5G and radio access technologies beyond 5G become more prevalent across industries and geographical areas, the demand for advanced services and applications with higher data rates grow. Accordingly, networks may have to utilize more antennas, larger bandwidths, and a greater number of frequency bands compared to other radio access technologies (e.g., 4G).

A wireless communications system may support wireless communications for one or more devices, such as UEs, base stations, network entities, satellites, and/or other devices, supporting wireless communications (e.g., control information, data, packets, etc.). The wireless communications system may consume substantial power or energy as a result of the various signaling aspects associated with the wireless communications between the various devices (e.g., UEs, base stations, network entities, satellites, and/or other devices). For example, one or more of the base stations or the network entities may consume power or energy to transmit one or more synchronization signal blocks (SSBs), including physical broadcast channel (PBCH) for MIB and system information block 1 (SIB1) transmissions. An energy saving option is to not provide these types of transmissions, but rather use an anchor cell as a proxy (for time-frequency synchronization and SIB1). Procedures and signaling methods support on-demand synchronization signal block (SSB) secondary cell (SCell) operation for UEs in a connected mode, as well as to implement triggering techniques, such as using a UE uplink wake-up-signal on an existing signal or channel, a cell on/off indication via backhaul, and/or SCell activation and deactivation signaling.

Energy consumption is a key part of network operating expenses, accounting for approximately one-quarter of the total operator cost. Most of the energy consumption comes from the radio access network and in particular, from the active antenna unit (AAU), with data centers and fiber transport accounting for a smaller share. The power consumption of a radio access can be split into two parts, namely a dynamic part which is only consumed when data transmission and reception is ongoing, and a static part during which power is consumed all of the time to maintain the necessary operation of the radio access devices, even when the data transmission and reception is not on-going.

There is a need for network energy savings and improved consumption model, particularly for base station (BS), key performance indicators (KPIs), and network energy savings techniques in targeted deployment scenarios. More efficient operations can be achieved dynamically and/or semi-statically, and a finer granularity adaptation of transmissions and/or receptions in one or more of network energy saving techniques in time, frequency, spatial, and power domains, with potential support and/or feedback from UE, potential UE assistance information, and information exchange and coordination over network interfaces. The potential network energy consumption gains can be evaluated so as to balance the impact on network and user performance, by looking at KPIs, such as spectral efficiency, capacity, user perceived throughput (UPT), latency, UE power consumption, complexity, handover performance, call drop rate, initial access performance, service level agreement (SLA) assurance related KPIs, etc.

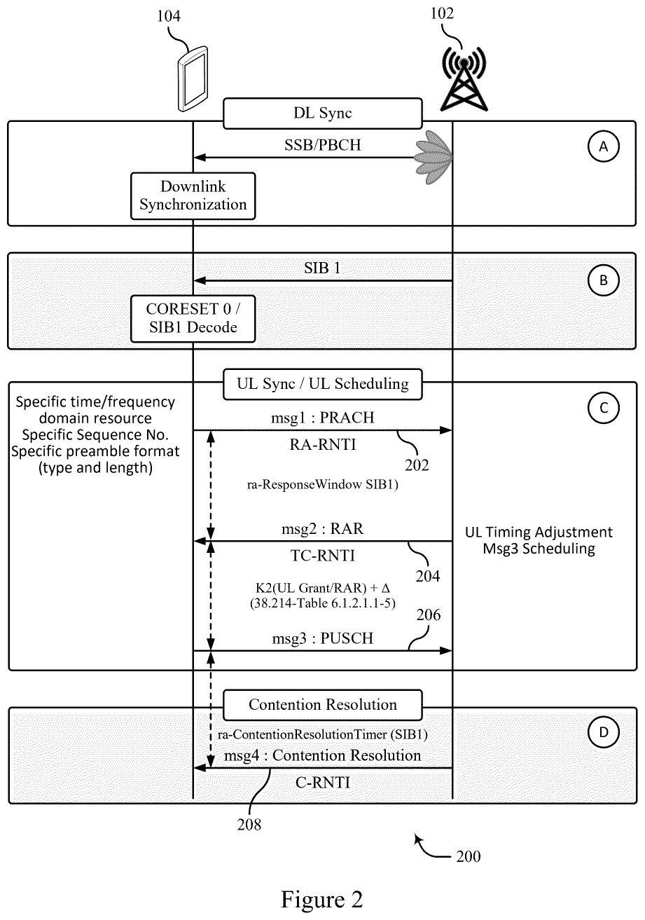

FIG. 2 illustrates an example signaling diagram 200 and procedures for 5G RACH, in accordance with aspects of the present disclosure. With reference to RACH in 5G, there are several different types of RACH processes and different use cases where each of those different procedures are used. For example, for RACH for NSA setup, short preamble [A]+[C]+[D] would be applicable. For contention based RACH in SAR, short preamble [A]+[B]+[C]+[D] would be applicable.

In this example signaling diagram, and for a Msg1 202 (preamble transmission), the UE 104 selects a random access preamble from a set of predefined preambles. In implementations, these preambles can be of two categories, short preamble format and long preamble format. The UE also selects a random sequence number for the preamble. After selecting the preamble and sequence number, the UE transmits the preamble on the physical random access channel (PRACH). For a Msg2 204 (random access response), and upon receiving Msg1, the gNB 102 (e.g., a BS) sends a response as Msg2. The Msg2 consists of several critical pieces of information, such as the time advance (TA) command for uplink timing adjustment, the RAPID matching the preamble sent by the UE, and an initial uplink grant for the UE. The gNB also assigns a temporary identifier called temporary cell radio network temporary identifier (TC-RNTI) to the UE.

For a Msg3 206, and using the initial uplink grant provided in Msg2, the UE 104 transmits the Msg3 on the physical uplink shared channel (PUSCH), which may carry a RRC message (e.g., RrcRequest) or is physical layer (PHY) data. For a Msg4 208 (contention resolution), and after processing Msg3, the gNB 102 transmits the Msg4 to the UE. The Msg4 is a MAC data which is for contention resolution. The contention resolution message contains the UE identity, confirming that the gNB has correctly identified the UE, and contention has been resolved. At this step, the network provides the UE with the cell radio network temporary identifier (C-RNTI).

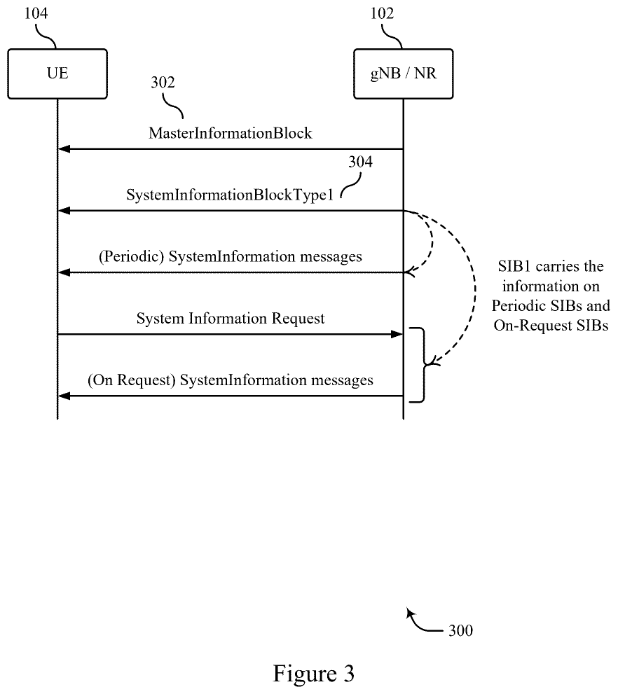

FIG. 3 illustrates an example signaling diagram 300 for MIB and SIB signaling between a UE and NE, in accordance with aspects of the present disclosure. In this example, the MIB 302 is transmitted over the broadcast channel (BCH) or PBCH (e.g., PBCH is transmitted as a part of SSB), and is transmitted with the periodicity of 80 ms (repetitive transmission occurs within this 80 ms). For initial cell selection, a UE 104 may assume that half frames with synchronization signal/physical broadcast channel (SS/PBCH) blocks occur with a periodicity of 2 frames. The MIB includes the parameters that are required to decode SIB1.

The MIB ::=SEQUENCE {

| | |
|---|---|
| systemFrameNumber | BIT STRING (SIZE (6)), |
| subCarrierSpacingCommon | ENUMERATED {scs15or60, scs30or120}, |
| ssb-SubcarrierOffset | INTEGER (0..15), |
| dmrs-TypeA-Position | ENUMERATED {pos2, pos3}, |
| pdcch-ConfigSIB1 | INTEGER (0..255), |
| cellBarred | ENUMERATED {barred, notBarred}, |
| intraFreqReselection | ENUMERATED {allowed, notAllowed}, |
| spare | BIT STRING (SIZE (1)) |

}

In this example, the subCarrierSpacingCommon indicates the subcarrier spacing for SIB1, Msg.2/4 for initial access and system information (SI)-messages. Interpretation of this value varies with the frequency range, such as for FR1: scs15or60 is 15 Khz, and scs30or120 is 30 Khz; and for FR2: scs15or60 is 60 Khz, and scs30or120 is 120 Khz. The ssb-SubcarrierOffset corresponds to k_ssb, which indicates the frequency domain offset between SSB and the overall resource block grid in number of subcarriers. If k_ssb requires the value higher than 15, it is represented by the combination of a PBCH data field and ssb-subcarrierOffset. The dmrs-TypeA-Position indicates a position of a first downlink (DL) demodulation reference signal (DM-RS). The pdcch-ConfigSIB1 indicates a bandwidth for physical downlink control channel (PDCCH) SIB, a common control resource set (CORESET), and a common search space and necessary PDCCH parameters. This corresponds to remaining minimum system information (RMSI)-PDCCH-Config.

In this example, the SIB1 304 (SystemInformationBlockType1) is transmitted over downlink shared channel (DL-SCH) (SIB1 is the first RRC message, except MIB). The UE 104 needs to be able to decode SIB1 without much information from an over-the-air (OTA) signaling message. Therefore, 3GPP defines a specific procedure to transmit and decode downlink control information (DCI) and PDSCH for SIB1. The SIB1 is transmitted with the periodicity of 160 ms (repetitive transmission occurs within this 160 ms). The SIB1 includes information regarding the availability and scheduling (e.g. periodicity, SI-window size) of other SIB, and the SIB1 indicates whether the other SIBs are provided via a periodic broadcast basis or only on-demand basis. If other SIBs than SIB1 are provided on-demand, the SIB1 includes information for the UE to perform a SI request.

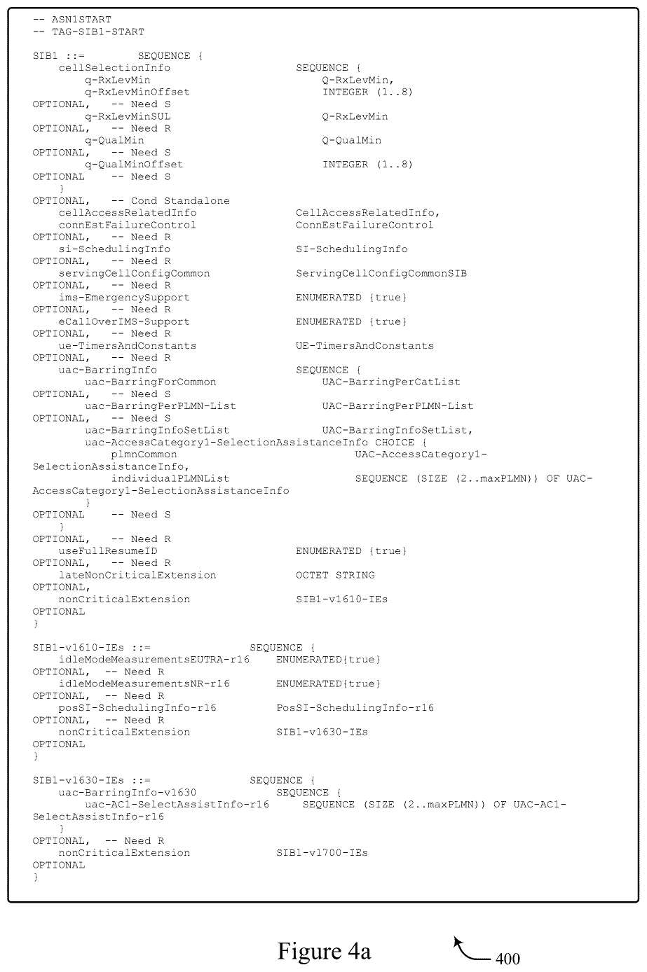

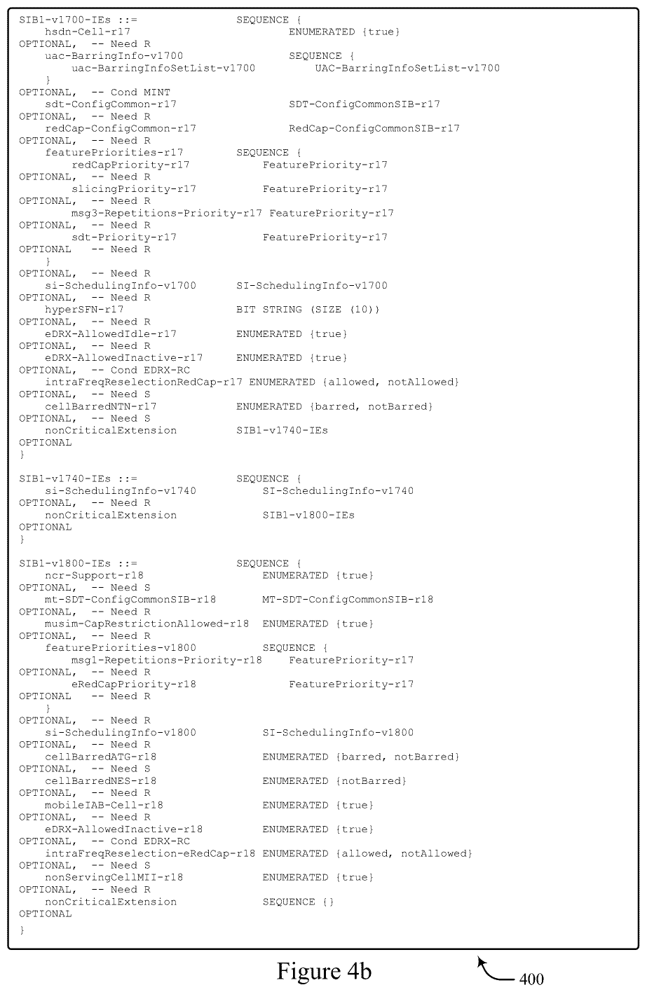

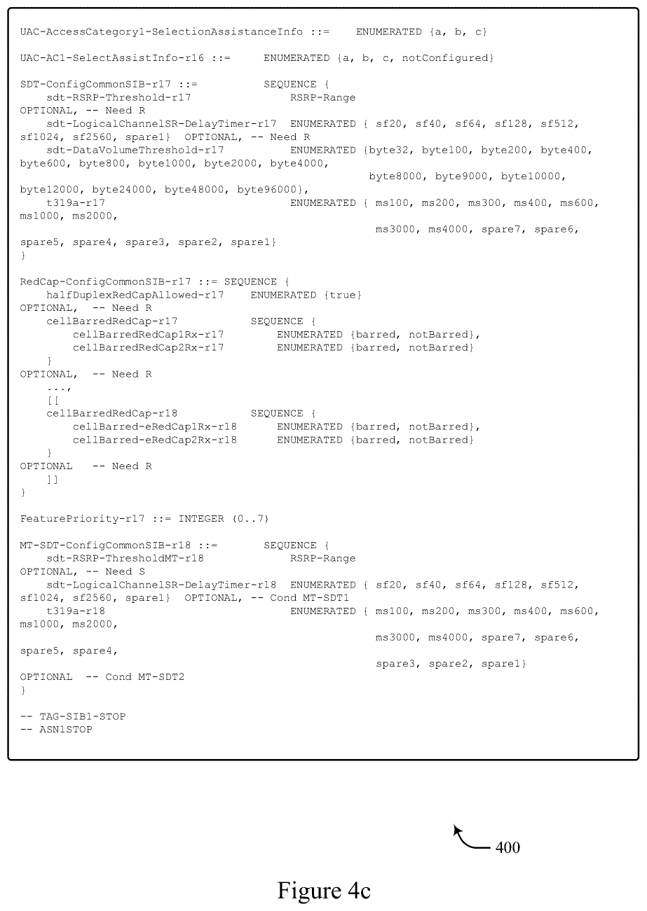

FIGS. 4a-c illustrate an example of SIB1 message configuration information 400 in accordance with aspects of the present disclosure. In this example, SIB1 contains information relevant when evaluating if a UE is allowed to access a cell and defines the scheduling of other system information. It also contains RRC information that is common for all UEs and barring information applied to the unified access control. The signaling radio bearer is N/A; the radio link control-service access point (RLC-SAP) is transparent mode (TM); the logical channels are broadcast control channel (BCCH); and the direction is network to UE. The SIB1 field descriptions are indicated in the table below.

SIB1 field descriptions
cellBarredATG
Value barred means that the cell is barred for connectivity to ATG, as defined in TS
38.304 [20]. Value notBarred means that the cell is allowed for connectivity to ATG. If
not present, the UE considers the cell is not allowed for connectivity to ATG, as defined
in TS 38.304 [20]. This field is only applicable to ATG-capable UEs.
cellBarred-eRedCap1Rx
Value barred means that the cell is barred for an eRedCap UE with 1 Rx branch, as
defined in TS 38.304 [20]. This field is ignored by non-eRedCap UEs.
cellBarred-eRedCap2Rx
Value barred means that the cell is barred for an eRedCap UE with 2 Rx branches, as
defined in TS 38.304 [20]. This field is ignored by non-eRedCap UEs.
cellBarredNES
The presence of this field indicates that the cell is allowed for UEs supporting NES cell
DTX/DRX.
cellBarredNTN
Value barred means that the cell is barred for connectivity to NTN, as defined in TS
38.304 [20]. Value notBarred means that the cell is allowed for connectivity to NTN. If
not present, the UE considers the cell is not allowed for connectivity to NTN, as defined
in TS 38.304 [20]. This field is only applicable to NTN-capable UEs.
cellBarredRedCap1Rx
Value barred means that the cell is barred for a RedCap UE with 1 Rx branch, as
defined in TS 38.304 [20]. This field is ignored by non-RedCap UEs.
cellBarredRedCap2Rx
Value barred means that the cell is barred for a RedCap UE with 2 Rx branches, as
defined in TS 38.304 [20]. This field is ignored by non-RedCap UEs.
cellSelectionInfo
Parameters for cell selection related to the serving cell.
eCallOverIMS-Support
Indicates whether the cell supports eCall over IMS services as defined in TS 23.501
[32]. If absent, eCall over IMS is not supported by the network in the cell.
eDRX-AllowedIdle
The presence of this field indicates that extended DRX for CN paging is allowed in the
cell for UEs in RRC_IDLE or RRC_INACTIVE. The UE shall stop using extended
DRX for CN paging in RRC_IDLE or RRC_INACTIVE if eDRX-AllowedIdle is not
present.
eDRX-AllowedInactive
The presence of eDRX-AllowedInactive-r17 this field indicates that extended DRX cycle
equal to or shorter than 10.24 s for RAN paging is allowed in the cell for UEs in
RRC_INACTIVE. The UE shall stop using extended DRX cycle equal to or shorter than
10.24 s for RAN paging in RRC_INACTIVE if eDRX-AllowedInactive-r17 is not
present. The presence of eDRX-AllowedInactive-r18 indicates that extended DRX cycle
longer than 10.24 s for RAN paging is allowed in the cell for UEs in RRC_INACTIVE.
The UE shall stop using extended DRX cycle longer than 10.24 s for RAN paging in
RRC_INACTIVE if eDRX-AllowedInactive-r18 is not present.
featurePriorities
Indicates priorities for features, such as (e)RedCap, Slicing, SDT, MSG1-Repetitions
and MSG3-Repetitions for Coverage Enhancements. These priorities are used to
determine which FeatureCombinationPreambles the UE shall use when a feature maps
to more than one FeatureCombinationPreambles, as specified in TS 38.321 [3]. A lower
value means a higher priority. The network does not signal the same priority for more
than one feature. The network signals a priority for all feature that map to at least one
FeatureCombinationPreambles.
halfDuplexRedCap-Allowed
The presence of this field indicates that the cell supports half-duplex FDD (e)RedCap
UEs.
hsdn-Cell
This field indicates this is a HSDN cell as specified in TS 38.304 [20].
hyperSFN
Indicates hyper SFN which increments by one when the SFN wraps around. This field is
excluded when determining changes in system information, i.e. changes of hyper SFN
should not result in system information change notifications.
idleModeMeasurementsEUTRA
This field indicates that a UE that is configured for EUTRA idle/inactive measurements
shall perform the measurements while camping in this cell and report availability of
these measurements when establishing or resuming a connection in this cell. If absent, a
UE is not required to perform EUTRA idle/inactive measurements.
idleModeMeasurementsNR
This field indicates that a UE that is configured for NR idle/inactive measurements shall
perform the measurements while camping in this cell and report availability of these
measurements when establishing or resuming a connection in this cell. If absent, a UE is
not required to perform NR idle/inactive measurements.
ims-EmergencySupport
Indicates whether the cell supports IMS emergency bearer services for UEs in limited
service mode. If absent, IMS emergency call is not supported by the network in the cell
for UEs in limited service mode.
intraFreqReselection-eRedCap
Controls cell selection/reselection to intra-frequency cells for eRedCap UEs when this
cell is barred, or treated as barred by the eRedCap UE, as specified in TS 38.304 [20]. If
not present, an eRedCap UE treats the cell as barred, i.e., the UE considers that the cell
does not support eRedCap.
intraFreqReselectionRedCap
Controls cell selection/reselection to intra-frequency cells for RedCap UEs when this
cell is barred, or treated as barred by the RedCap UE, as specified in TS 38.304 [20]. If
not present, a RedCap UE treats the cell as barred, i.e., the UE considers that the cell does
not support RedCap.
mobileIAB-Cell
The presence of this field indicates that this is a mobile IAB cell.
musim-CapRestrictionAllowed
Indicates the UE is allowed to send the musim-CapRestrictionInd in RRCSetupComplete
and RRCResumeComplete messages.
ncr-Support
This field combines both the support of NCR and the cell status for NCR. If the field is
present, the cell supports NCR and the cell is also considered as a candidate for cell
(re)selection for NCR-node; if the field is absent, the cell does not support NCR and/or
the cell is barred for NCR-node.
nonServingCellMII
Indicates whether the MBSInterestIndication message for MBS broadcast reception on a
non-serving cell is allowed to be transmitted to the serving gNB.
q-QualMin
Parameter “Q_{qualmin}” in TS 38.304 [20], applicable for serving cell. If the field is absent,
the UE applies the (default) value of negative infinity for Q_{qualmin}.
q-QualMinOffset
Parameter “Q_{qualminoffset}” in TS 38.304 [20]. Actual value Q_{qualminoffset} = field value [dB].
If the field is absent, the UE applies the (default) value of 0 dB for Q_{qualminoffset}. Affects
the minimum required quality level in the cell.
q-RxLevMin
Parameter “Qᵣₓₗₑᵥₘᵢₙ” in TS 38.304 [20], applicable for serving cell.
q-RxLevMinOffset
Parameter “Q_{rxlevminoffset}” in TS 38.304 [20]. Actual value Q_{rxlevminoffset} = field value * 2
[dB]. If absent, the UE applies the (default) value of 0 dB for Q_{rxlevminoffset}. Affects the
minimum required Rx level in the cell.
q-RxLevMinSUL
Parameter “Qᵣₓₗₑᵥₘᵢₙ” in TS 38.304 [20], applicable for serving cell.
sdt-DataVolumeThreshold
Data volume threshold used to determine whether SDT can be initiated, as specified in
TS 38.321 [3]. Value byte32 corresponds to 32 bytes, value byte100 corresponds to 100
bytes, and so on.
sdt-LogicalChannelSR-DelayTimer
The value of logicalChannelSR-DelayTimer applied during SDT for logical channels
configured with SDT, as specified in TS 38.321 [3]. Value in number of subframes.
Value sf20 corresponds to 20 subframes, sf40 corresponds to 40 subframes, and so on. If
sdt-LogicalChannelSR-DelayTimer-r18 is absent and sdt-LogicalChannelSR-
DelayTimer-r17 is present then, the UE applies the value configured in sdt-
LogicalChannelSR-DelayTimer-r17 for this field. If this field is not configured, then
logicalChannelSR-DelayTimer is not applied for SDT logical channels.
sdt-RSRP-Threshold
RSRP threshold used to determine whether SDT procedure can be initiated, as specified
in TS 38.321 [3].
sdt-RSRP-ThresholdMT
RSRP threshold used to determine whether MT-SDT procedure can be initiated, as
specified in TS 38.321 [3]. If the field is absent, and the field sdt-RSRP-Threshold is
present, the UE applies the value in the field sdt-RSRP-Threshold.
servingCellConfigCommon
Configuration of the serving cell.
t319a
Initial value of the timer T319a used for detection of SDT failure. Value ms100
corresponds to 100 milliseconds, value ms200 corresponds to 200 milliseconds and so
on. If 1319a-r18 is absent, the UE applies the value configured in t319a-r17.
uac-AccessCategory1-SelectionAssistanceInfo
Information used to determine whether Access Category 1 applies to the UE, as defined
in TS 22.261 [25]. If plmnCommon is chosen, the UAC-AccessCategory1-
SelectionAssistanceInfo is applicable to all the PLMNs and SNPNs in plmn-
IdentityInfoList and npn-IdentityInfoList. If individualPLMNList is chosen, the 1^{st} entry
in the list corresponds to the first network within all of the PLMNs and SNPNs across
the plmn-IdentityList and the npn-IdentityInfoList, the 2^{nd} entry in the list corresponds to
the second network within all of the PLMNs and SNPNs across the plmn-IdentityList
and the npn-IdentityInfoList and so on. If uac-AC1-SelectAssistInfo-r16 is present, the
UE shall ignore the uac-AccessCategory1-SelectionAssistanceInfo.
uac-AC1-SelectAssistInfo
Information used to determine whether Access Category 1 applies to the UE, as defined
in TS 22.261 [25]. The 1^{st} entry in the list corresponds to the first network within all of
the PLMNs and SNPNs across the plmn-IdentityList and npn-IdentityInfoList, the 2^{nd}
entry in the list corresponds to the second network within all of the PLMNs and SNPNs
across the plmn-IdentityList and the npn-IdentityInfoList and so on. Value notConfigured
indicates that Access Category 1 is not configured for the corresponding PLMN/SNPN.
uac-BarringForCommon
Common access control parameters for each access category. Common values are used
for all PLMNs/SNPNs, unless overwritten by the PLMN/SNPN specific configuration
provided in uac-BarringPerPLMN-List. The parameters are specified by providing an
index to the set of configurations (uac-BarringInfoSetList). UE behaviour upon absence
of this field is specified in clause 5.3.14.2.
ue-TimersAndConstants
Timer and constant values to be used by the UE. The cell operating as PCell always
provides this field.
useFullResumeID
Indicates which resume identifier and Resume request message should be used. UE uses
fullI-RNTI and RRCResumeRequest1 if the field is present, or shortI-RNTI and
RRCResume Request if the field is absent.

| Conditional | |
|---|---|
| Presence | Explanation |
| EDRX-RC | The field is optionally present, Need R, in a cell that |
| | enables eDRX-AllowedIdle, otherwise it is absent. |
| MINT | The field is optionally present, Need R, in a cell that |
| | provides a configuration for disaster roaming, otherwise it |
| | is absent, Need R. |
| MT-SDT1 | This field is optionally present, Need S, in a cell that |
| | supports MT-SDT if sdt-ConfigCommon-r17 is not |
| | present, otherwise it is absent. |
| MT-SDT2 | This field is mandatory present in a cell that supports MT- |
| | SDT if sdt-ConfigCommon-r17 is not present, otherwise it |
| | is absent. |
| Standalone | The field is mandatory present in a cell that supports |
| | standalone operation, otherwise it is absent. |

With reference to an existing DCI format used with RA-RNTI, SI-RNTI, and/or MsgB-RNTI, and for example purposes, this disclosure describes various implementations by using DCI format 1_0 (e.g. as specified in 3GPP TS 38.212 v18.0.0), however it is to be understood that such description is not limiting the scope to the use of DCI format 1_0. Information is transmitted utilizing the DCI format 1_0 with cyclic redundancy check (CRC) scrambled by RA-RNTI or MsgB-RNTI. The information includes frequency domain resource assignment—

$$⌈ {log}_{2} ( {N}_{R B}^{DL , BWP} ( {N}_{R B}^{DL , BWP} + 1 ) / 2 ) ⌉ bits ,$$

where

$${N}_{R B}^{DL , BWP}$$

is the size of CORESET 0 if CORESET 0 is configured for the cell and

$${N}_{R B}^{DL , BWP}$$

is the size of initial downlink (DL) bandwidth part if CORESET 0 is not configured for the cell. The information also includes time domain resource assignment (4 bits), virtual resource block (VRB)-to-physical resource block (PRB) mapping (1 bit), a modulation and coding scheme (5 bits), a transport block (TB) scaling (2 bits). The information also includes least significant bits (LSBs) of system frame number (SFN) (2 bits) for the DCI format 1_0 with CRC scrambled by MsgB-RNTI if msgB-responseWindow is configured to be larger than 10 ms; or 2 bits for the DCI format 1_0 with CRC scrambled by RA-RNTI for operation in a cell with shared spectrum channel access if ra-ResponseWindow or ra-ResponseWindow-v1610 is configured to be larger than 10 ms; 0 bit otherwise. The information also includes reserved bits (16-A) bits for operation in a cell without shared spectrum access in frequency range 1 and frequency range 2-1, (18-A) for operation in a cell with shared spectrum access in frequency range 1 or for operation in a cell in frequency range 2-2, where the value of A is the number of bits for the field of LSBs of SFN as indicated above.

Additionally, information is transmitted by utilizing the DCI format 1_0 with CRC scrambled by SI-RNTI. The information includes frequency domain resource assignment—

$$⌈ {log}_{2} ( {N}_{R B}^{DL , BWP} ( {N}_{R B}^{DL , BWP} + 1 ) / 2 ) ⌉ bits ,$$

where

$${N}_{R B}^{DL , BWP}$$

is the size of CORESET 0. The information also includes time domain resource assignment (4 bits), VRB-to-PRB mapping (1 bit), a modulation and coding scheme (5 bits), a redundancy version (2 bits), a system information indicator (1 bit), and reserved bits (17 bits) for operation in a cell with shared spectrum channel access in frequency range 1 or for operation in a cell in frequency range 2-2; otherwise 15 bits. A system information indicator for a bit field value of zero (0) is SIB1, and a system information indicator for a bit field value of one (1) is an SI message.

Aspects of the present disclosure include using DCI scrambled with RA-RNTI, SI-RNTI, and/or MsgB-RNTI, and FDRA indicated as all ones (‘1’) to indicate SIB1 transmission request acknowledgement. The techniques include RAPID or a requested cell ID in the acknowledgement message for contention resolution. The techniques also include indicating SIB1 transmission in DCI that indicates acknowledgement, and defining a new RNTI and DCI fields for DCI indicating acknowledgement for the SIB1 transmission request.

In aspects of the described techniques, a UE indicates a SIB1 transmission request by a PRACH (preamble transmission), which may be tied to a cell index for which the SIB1 is transmitted. A gNB transmits a reply message similar to RACH procedure Msg2 or MsgB (i.e., DCI and/or PDSCH). In one or more implementations, a gNB transmits a DCI format scrambled with an RA-RNTI or MsgB-RNTI, and a UE determines whether gNB transmits a DCI format scrambled with an RA-RNTI or MsgB-RNTI after the UE has transmitted a SIB1 transmission request. For cases where a DCI in Msg2 or MsgB is scrambled by an RA-RNTI or MsgB-RNTI (as applicable), the RA-RNTI or MsgB-RNTI used for this purpose may be a fixed value. Alternatively, the RA-RNTI or MsgB-RNTI is calculated by a formula as specified in 5G.

The RA-RNTI associated with the PRACH where random access preamble is transmitted can be computed as RA-RNTI=1+s_id+14×t_id+14×80×f_id+14×80×8×ul_carrier_id, where s_id is the index of the first OFDM symbol of the PRACH occasion (0≤s_id<14); t_id is the index of the first slot of the PRACH occasion in a system frame (0≤t_id<80), where the subcarrier spacing to determine t_id is based on the value of μ; for μ={0, 1, 2, 3}, and for μ={5, 6}, t_id is the index of the 120 kHz slot in a system frame that contains the PRACH occasion (0≤t_id<80); f_id is the index of the PRACH occasion in the frequency domain (0≤f_id<8); and ul_carrier_id is the uplink (UL) carrier used for random access preamble transmission (0 for NUL carrier, and 1 for SUL carrier).

The MsgB-RNTI associated with the PRACH occasion in which the random access preamble is transmitted, is computed as MsgB-RNTI=1+s_id+14×t_id+14×80×f_id+14×80×8×ul_carrier_id+14×80×8×2, where s_id is the index of the first OFDM symbol of the PRACH occasion (0≤s_id<14); t_id is the index of the first slot of the PRACH occasion in a system frame (0≤t_id<80), where the subcarrier spacing to determine t_id is based on the value of μ; for μ={0, 1, 2, 3}, and for μ={5, 6}, t_id is the index of the 120 kHz slot in a system frame that contains the PRACH occasion (0≤t_id<80); f_id is the index of the PRACH occasion in the frequency domain (0≤f_id<8); and ul_carrier_id is the UL carrier used for random access preamble transmission (0 for NUL carrier, and 1 for SUL carrier).

One or more of the parameters s_id, t_id, f_id may be determined from the configuration, where a PRACH may be transmitted for requesting a SIB1 transmission, or may be set to fixed values in case the RA-RNTI or MsgB-RNTI is used in a SIB1 transmission request procedure. Alternatively, t_id may be the slot number in the system frame where the PRACH for requesting a SIB1 transmission is transmitted, and ul_carrier_id may be fixed to 0.

In one or more implementations, the DCI format does not contain any of the following fields: Frequency domain resource assignment, Time domain resource assignment, VRB-to-PRB mapping, Modulation and coding scheme, TB scaling. This implies that the gNB confirms the reception of a SIB1 transmission request. A UE receiving this DCI format subsequently checks for DCI formats scheduling one or more SIB1 transmissions (e.g., based on a configuration of CORESET0 resources). A UE subsequently not detecting DCI formats scheduling one or more SIB1 transmissions may restart the SIB1 transmission request procedure as if the DCI had not been detected. According to an implementation, the DCI format contains one or more elements (as related to description of DCI format 1_0 with CRC scrambled by RA-RNTI or MsgB-RNTI): Frequency domain resource assignment, Time domain resource assignment, VRB-to-PRB mapping, Modulation and coding scheme, TB scaling, LSBs of SFN, reserved bits.

In an implementation, the DCI format contains a FDRA field with all bits set to value ‘1’. This implies that the gNB confirms the reception of a SIB1 transmission request. A UE receiving this DCI format with all FDRA bits set to ‘1’ subsequently checks for DCI formats scheduling one or more SIB1 transmissions (e.g., based on a configuration of CORESET0 resources).

In an implementation, the DCI format contains the RAPID of the preamble that was received from a UE requesting a SIB1 transmission. A UE detecting that the RAPID in the DCI matches the RAPID of the preamble that it used to transmit the SIB1 transmission request subsequently checks for DCI formats scheduling one or more SIB1 transmissions (e.g., based on a configuration of CORESET0 resources). A UE detecting that the RAPID in the DCI doesn't match the RAPID of the preamble that it used to transmit the SIB1 transmission request or subsequently not detecting DCI formats scheduling one or more SIB1 transmissions may restart the SIB1 transmission request procedure as if the DCI had not been detected.

In an implementation, the DCI format contains the cell ID for which the gNB has received a SIB1 transmission request. A UE detecting that the cell ID in the DCI matches the cell ID for which it has transmitted a SIB1 transmission request subsequently checks for DCI formats scheduling one or more SIB1 transmissions (e.g., based on a configuration of CORESET0 resources). A UE detecting that the cell ID in the DCI doesn't match the cell ID for which it has transmitted a SIB1 transmission request or subsequently not detecting DCI formats scheduling one or more SIB1 transmissions may restart the SIB1 transmission request procedure as if the DCI had not been detected.

In one or more implementations, the DCI format contains information to indicate transmission resources for a PDSCH transmission. Accordingly, the DCI format can contain information to indicate transmission resources for the SIB1 transmission in a PDSCH (e.g., by indicating time and frequency resources and a modulation and coding scheme). If present, fields for VRB-to-PRB mapping and TB scaling may be reserved or set to a fixed value.

In an implementation, the PDSCH scheduled by the DCI format contains the RAPID of the preamble that was received from a UE requesting a SIB1 transmission. A UE detecting that the RAPID in the DCI matches the RAPID of the preamble that it used to transmit the SIB1 transmission request subsequently processes the SIB1 in the scheduled PDSCH. A UE detecting that the RAPID in the DCI doesn't match the RAPID of the preamble that it used to transmit the SIB1 transmission request may discard the SIB1 in the scheduled PDSCH and may restart the SIB1 transmission request procedure as if the DCI had not been detected.

In an implementation, the PDSCH scheduled by the DCI format includes an indication of the cell ID for which SIB1 is transmitted. The cell ID may be conveyed by utilizing an information element within the transmitted SIB1, or by utilizing a medium access control (MAC) control element (CE) multiplexed with the SIB1, or by utilizing information in the PDSCH payload multiplexed with the SIB1. A UE detecting that the cell ID in the PDSCH matches the cell ID for which it has transmitted a SIB1 transmission request subsequently processes the SIB1 in the PDSCH. A UE detecting that the cell ID in the PDSCH doesn't match the cell ID for which it has transmitted a SIB1 transmission request may discard the SIB1 in the scheduled PDSCH and may restart the SIB1 transmission request procedure.

In one or more implementations, the PDSCH indicated by the DCI format includes an acknowledgement of the reception of the SIB1 transmission request. According to a specific implementation, the acknowledgement may include a MAC sub-PDU consisting of a MAC sub-header with the RAPID of the preamble that was received from a UE requesting a SIB1 transmission. In an implementation, the acknowledgement may include scheduling information for one or more SIB1 transmissions.

In one or more implementations, the DCI format scrambled with an RA-RNTI or MsgB-RNTI may include a first bit or a field setting that configures whether and/or which implementation is being used. For example a first bit or field value indicates to the UE that no PDSCH scheduling information is included in the DCI. A second bit or field value indicates to the UE that the scheduled PDSCH includes SIB1 information. A second bit or field value indicates to the UE that the scheduled PDSCH includes acknowledgement information.

In one or more additional implementations, a gNB transmits a DCI format scrambled with SI-RNTI, and a UE determines whether gNB transmits a DCI format scrambled with the SI-RNTI after the UE has transmitted a SIB1 transmission request. In an implementation, the DCI format does not contain any of the following fields: Frequency domain resource assignment, Time domain resource assignment, VRB-to-PRB mapping, Modulation and coding scheme, Redundancy version, System information indicator. This implies that the gNB confirms the reception of a SIB1 transmission request. A UE receiving this DCI format subsequently checks for DCI formats scheduling one or more SIB1 transmissions (e.g., based on a configuration of CORESET0 resources). A UE subsequently not detecting DCI formats scheduling one or more SIB1 transmissions may restart the SIB1 transmission request procedure as if the DCI had not been detected.

In an implementation, the DCI format contains one or more elements (as related to description of DCI format 1_0 with CRC scrambled by SI-RNTI): Frequency domain resource assignment, Time domain resource assignment, VRB-to-PRB mapping, Modulation and coding scheme, Redundancy version, System information indicator, reserved bits. According to the implementation, the DCI format contains a system information indicator field set to the value ‘0’. In another implementation, the DCI format contains a FDRA, field with all bits set to value ‘1’. This implies that the gNB confirms the reception of a SIB1 transmission request. A UE receiving this DCI format with all FDRA bits set to ‘1’ subsequently checks for DCI formats scheduling one or more SIB1 transmissions, e.g. based on a configuration of CORESET0 resources.

According to an implementation, the DCI format contains the random access preamble ID (RAPID) of the preamble that was received from a UE requesting a SIB1 transmission. A UE detecting that the RAPID in the DCI matches the RAPID of the preamble that it used to transmit the SIB1 transmission request subsequently checks for DCI formats scheduling one or more SIB1 transmissions (e.g., based on a configuration of CORESET0 resources). A UE detecting that the RAPID in the DCI doesn't match the RAPID of the preamble that it used to transmit the SIB1 transmission request or subsequently not detecting DCI formats scheduling one or more SIB1 transmissions may restart the SIB1 transmission request procedure as if the DCI had not been detected.

In another implementation, the DCI format contains the cell ID for which the gNB has received a SIB1 transmission request. A UE detecting that the cell ID in the DCI matches the cell ID for which it has transmitted a SIB1 transmission request subsequently checks for DCI formats scheduling one or more SIB1 transmissions (e.g., based on a configuration of CORESET0 resources. A UE detecting that the cell ID in the DCI doesn't match the cell ID for which it has transmitted a SIB1 transmission request or subsequently not detecting DCI formats scheduling one or more SIB1 transmissions may restart the SIB1 transmission request procedure as if the DCI had not been detected.

In one or more implementations, the DCI format contains information to indicate transmission resources for a PDSCH transmission. Accordingly, the DCI format contains a system information indicator field set to the value ‘0’. In an implementation, the DCI format contains information to indicate transmission resources for the SIB1 transmission in a PDSCH (e.g., by indicating time and frequency resources and a modulation and coding scheme). If present, fields for VRB-to-PRB mapping may be reserved or set to a fixed value. According to an implementation, the DCI format contains one or more bits that indicate a retransmission or repetition pattern. This may indicate a slot pattern when to check for additional DCI scrambled with SI-RNTI (indicating repetitions or retransmissions of the SIB1), or it may indicate a pattern of slots where additional retransmissions or repetitions of the SIB1 occur (i.e., no need for subsequent DCI detection by a UE). Such repetition or retransmission may use the same resource allocation as that indicated in the first DCI format scrambled with SI-RNTI. Alternatively, the repetitions or retransmissions apply a frequency hopping pattern and/or a redundancy version progression, which may be according to a defined rule or indicated as part of the DCI. An example is that the first SIB1 transmission uses the RV as indicated, subsequent SIB1 repetitions or retransmissions follow the next RV from the sequence {0,2,3,1} as appropriate.

In an implementation, the DCI format contains the RAPID of the preamble that was received from a UE requesting a SIB1 transmission. A UE detecting that the RAPID in the DCI matches the RAPID of the preamble that it used to transmit the SIB1 transmission request subsequently detects the SIB1 in the scheduled PDSCH. A UE detecting that the RAPID in the DCI doesn't match the RAPID of the preamble that it used to transmit the SIB1 transmission request may restart the SIB1 transmission request procedure as if the DCI had not been detected.

According to an implementation, the PDSCH scheduled by the DCI format contains the RAPID of the preamble that was received from a UE requesting a SIB1 transmission. A UE detecting that the RAPID in the DCI matches the RAPID of the preamble that it used to transmit the SIB1 transmission request subsequently processes the SIB1 in the scheduled PDSCH. A UE detecting that the RAPID in the DCI doesn't match the RAPID of the preamble that it used to transmit the SIB1 transmission request may discard the SIB1 in the scheduled PDSCH and may restart the SIB1 transmission request procedure as if the DCI had not been detected.

According to another implementation, the DCI format includes a field to indicate the cell ID for which SIB1 is transmitted in the scheduled PDSCH. A UE detecting that the cell ID in the DCI matches the cell ID for which it has transmitted a SIB1 transmission request subsequently detects the SIB1 in the scheduled PDSCH. A UE detecting that the cell ID in the DCI doesn't match the cell ID for which it has transmitted a SIB1 transmission request may ignore the scheduled PDSCH and restart the SIB1 transmission request procedure as if the DCI had not been detected.

In an implementation, the PDSCH scheduled by the DCI format includes an indication of the cell ID for which SIB1 is transmitted. The cell ID may be conveyed by means of an information element within the transmitted SIB1, or by means of a MAC CE multiplexed with the SIB1, or by means of information in the PDSCH payload multiplexed with the SIB1. A UE detecting that the cell ID in the PDSCH matches the cell ID for which it has transmitted a SIB1 transmission request subsequently processes the SIB1 in the PDSCH. A UE detecting that the cell ID in the PDSCH doesn't match the cell ID for which it has transmitted a SIB1 transmission request may ignore the SIB1 in the PDSCH and may restart the SIB1 transmission request procedure.

In one or more implementations, a gNB transmits a DCI format scrambled with a SIB1-RNTI, the SIB1-RNTI being different from RA-RNTI, MsgB-RNTI, and SI-RNTI values. For example the SIB1-RNTI is an RNTI that is unambiguously associated with SIB1-RNTI (i.e. cannot represent another RNTI). A UE determines whether gNB transmits a DCI format scrambled with the SIB1-RNTI after the UE has transmitted a SIB1 transmission request.

In an implementation, the DCI format does not contain any of the following fields: Frequency domain resource assignment, Time domain resource assignment, VRB-to-PRB mapping, Modulation and coding scheme, Redundancy version, System information indicator. This implies that the gNB confirms the reception of a SIB1 transmission request. A UE receiving this DCI format subsequently checks for DCI formats scheduling one or more SIB1 transmissions (e.g., based on a configuration of CORESET0 resources). A UE subsequently not detecting DCI formats scheduling one or more SIB1 transmissions may restart the SIB1 transmission request procedure as if the DCI had not been detected.

In an implementation, the DCI format contains the random access preamble ID (RAPID) of the preamble that was received from a UE requesting a SIB1 transmission. A UE detecting that the RAPID in the DCI matches the RAPID of the preamble that it used to transmit the SIB1 transmission request subsequently checks for DCI formats scheduling one or more SIB1 transmissions (e.g., based on a configuration of CORESET0 resources). A UE detecting that the RAPID in the DCI doesn't match the RAPID of the preamble that it used to transmit the SIB1 transmission request or subsequently not detecting DCI formats scheduling one or more SIB1 transmissions may restart the SIB1 transmission request procedure as if the DCI had not been detected.

According to a specific implementation, the DCI format contains the cell ID for which the gNB has received a SIB1 transmission request. A UE detecting that the cell ID in the DCI matches the cell ID for which it has transmitted a SIB1 transmission request subsequently checks for DCI formats scheduling one or more SIB1 transmissions, e.g. based on a configuration of CORESET0 resources. A UE detecting that the cell ID in the DCI doesn't match the cell ID for which it has transmitted a SIB1 transmission request or subsequently not detecting DCI formats scheduling one or more SIB1 transmissions may restart the SIB1 transmission request procedure as if the DCI had not been detected.

In one or more implementations, the DCI format contains information to indicate transmission resources for a PDSCH transmission including SIB1 information. Accordingly, the DCI format contains one or more of the following elements (as related to description of DCI format 1_0 with CRC scrambled by SI-RNTI): Frequency domain resource assignment, Time domain resource assignment, VRB-to-PRB mapping, Modulation and coding scheme, Redundancy version, System information indicator, reserved bits. In implementations, the DCI format contains system information indicator field set to the value ‘0’. The DCI format contains information to indicate transmission resources for the SIB1 transmission in a PDSCH (e.g., by indicating time and frequency resources and a modulation and coding scheme).

In an implementation, the DCI format contains one or more bits that indicate a retransmission or repetition pattern. This may indicate a slot pattern when to check for additional DCI scrambled with SIB1-RNTI (indicating repetitions or retransmissions of the SIB1), or it may indicate a pattern of slots where additional retransmissions or repetitions of the SIB1 occur (i.e., no need for subsequent DCI detection by a UE). Such repetition or retransmission may use the same resource allocation as that indicated in the first DCI format scrambled with SIB1-RNTI. Alternatively, the repetitions or retransmissions apply a frequency hopping pattern and/or a redundancy version progression, which may be according to a defined rule or indicated as part of the DCI. An example is that the first SIB1 transmission uses the RV as indicated, subsequent SIB1 repetitions or retransmissions follow the next RV from the sequence {0,2,3,1} as appropriate.

In implementations, the DCI format contains the RAPID of the preamble that was received from a UE requesting a SIB1 transmission. A UE detecting that the RAPID in the DCI matches the RAPID of the preamble that it used to transmit the SIB1 transmission request subsequently detects the SIB1 in the scheduled PDSCH. A UE detecting that the RAPID in the DCI doesn't match the RAPID of the preamble that it used to transmit the SIB1 transmission request may restart the SIB1 transmission request procedure as if the DCI had not been detected.

In an implementation, the PDSCH scheduled by the DCI format contains the RAPID of the preamble that was received from a UE requesting a SIB1 transmission. A UE detecting that the RAPID in the PDSCH matches the RAPID of the preamble that it used to transmit the SIB1 transmission request subsequently processes the SIB1 in the scheduled PDSCH. A UE detecting that the RAPID in the PDSCH doesn't match the RAPID of the preamble that it used to transmit the SIB1 transmission request may discard the SIB1 in the scheduled PDSCH and may restart the SIB1 transmission request procedure as if the DCI had not been detected.

In another implementation, the DCI format includes a field to indicate the cell ID for which SIB1 is transmitted in the scheduled PDSCH. A UE detecting that the cell ID in the DCI matches the cell ID for which it has transmitted a SIB1 transmission request subsequently detects the SIB1 in the scheduled PDSCH. A UE detecting that the cell ID in the DCI doesn't match the cell ID for which it has transmitted a SIB1 transmission request may ignore the scheduled PDSCH and restart the SIB1 transmission request procedure as if the DCI had not been detected.

In another implementation, the PDSCH scheduled by the DCI format includes an indication of the cell ID for which SIB1 is transmitted. The cell ID may be conveyed by means of an information element within the transmitted SIB1, or by means of a MAC CE multiplexed with the SIB1, or by means of information in the PDSCH payload multiplexed with the SIB1. A UE detecting that the cell ID in the PDSCH matches the cell ID for which it has transmitted a SIB1 transmission request subsequently processes the SIB1 in the PDSCH. A UE detecting that the cell ID in the PDSCH doesn't match the cell ID for which it has transmitted a SIB1 transmission request may ignore the SIB1 in the PDSCH and may restart the SIB1 transmission request procedure.

According to one or more of the implementations described above, the requested SIB1 includes an indication of the transmission resources for other system information (OSI) for the cell. The OSI typically is conveyed by a system information (SI) message that is composed of one or more system information blocks (except for SIB1; e.g. SIB2, SIB3, . . . ). The indication of transmission resources may include information about a search space used for scheduling OSI. In the absence of such a search space configuration, a UE may check the same search space that scheduled the requested SIB1 transmission. The indication may include information about a transmission window, transmission periodicity, transmission broadcast status. According to an implementation, the SIB1 transmitted according to the invention includes an indication about the SIB mapping (i.e., which SIB type (such as SIB2, SIB3, . . . ) is mapped to which SI message). According to an implementation, these information elements may be formally independent of information elements that are used in a periodic SIB1 transmission. For example, the periodic transmission of SIB1 may indicate a periodicity of 128 radio frames, whereas the requested transmission of SIB1 may indicate a periodicity of 32 radio frames; likewise the SIB mapping indicated by a periodic transmission of SIB1 may indicate that each SI carries only one of the various SIB types, while the mapping indicated by a requested SIB1 transmission may indicate that a first SI carries SIB2+SIB3+SIB4 while a second SI carries SIB5+SIB6. According to a specific implementation, the indication may include a time window indication for the transmission or reception of OSI following the requested SIB1 transmission. This time window may indicate a number of radio frames during which a UE should check a search space for OSI transmission(s).

In implementations, and if the DCI serves as a plain acknowledgement message, a UE stops the SIB1 transmission request procedure upon receiving the acknowledgement. In other implementations, a UE not detecting a DCI according to any implementation within a defined time period after transmitting the SIB1 transmission request may restart the procedure with a new transmission of a SIB1 transmission request, potentially with an increased transmit power of the preamble.

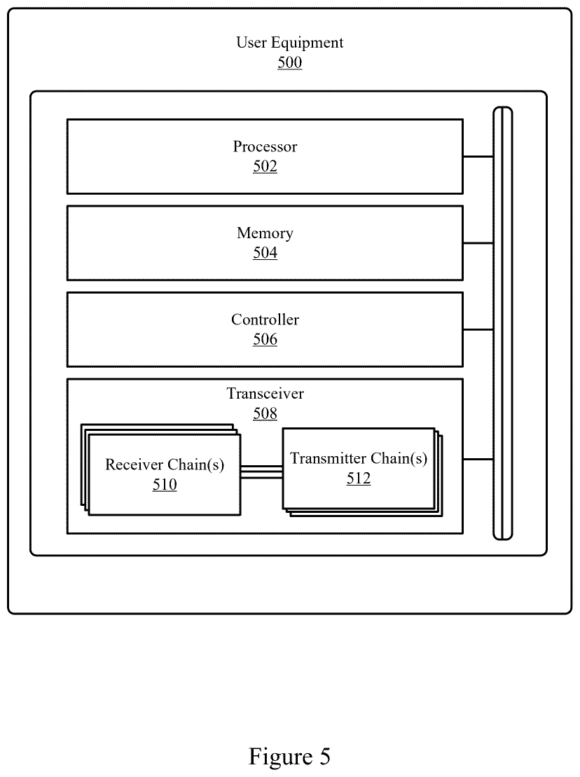

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such as the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein. The UE 500 may be configured to or operable to support a means for transmitting, to a NE, a request for one or more SIB1 transmissions; and receiving, from the NE, a first DCI in a format scrambled with a RNTI, the first DCI being determinable by the UE as an acknowledgement.

Additionally, the UE 500 may be configured to support any one or combination of the method further comprising stopping a SIB1 transmission request procedure based on the first DCI in the format scrambled with the RNTI determined as the acknowledgement. The RNTI is at least one of a RA-RNTI, MsgB-RNTI, a SI-RNTI, or a SIB1-RNTI. The method further comprising detecting a SIB1 transmission based on detection of the first DCI. To detect the SIB1 transmission, the format scrambled with a SI-RNTI configures the UE to detect a second DCI. The SIB1 transmission is scheduled according to the first DCI. The SIB1 transmission is scheduled according to a PDSCH that is scheduled by the first DCI. The method further comprising restarting a SIB1 transmission request procedure based on the UE does not detect the first DCI as the acknowledgement.

Additionally, or alternatively, the UE 500 may support at least one memory (e.g., the memory 504) and at least one processor (e.g., the processor 502) coupled with the at least one memory and configured to cause the UE to transmit, to a NE, a request for one or more SIB1 transmissions; and receive, from the NE, a first DCI in a format scrambled with a RNTI, the first DCI being determinable by the UE as an acknowledgement.

Additionally, the UE 500 may be configured to support any one or combination of the at least one processor is configured to cause the UE to stop a SIB1 transmission request procedure based on the first DCI in the format scrambled with the RNTI determined as the acknowledgement. The RNTI is at least one of a RA-RNTI, a MsgB-RNTI, a SI-RNTI, or a SIB1-RNTI. The at least one processor is configured to cause the UE to detect a SIB1 transmission based on detection of the first DCI. To detect the SIB1 transmission, the format scrambled with a SI-RNTI configures the at least one processor to cause the UE to detect a second DCI. The SIB1 transmission is scheduled according to the first DCI. The SIB1 transmission is scheduled according to a PDSCH that is scheduled by the first DCI. The at least one processor is configured to cause the UE to restart a SIB1 transmission request procedure based on the UE does not detect the first DCI as the acknowledgement.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas to receive a signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

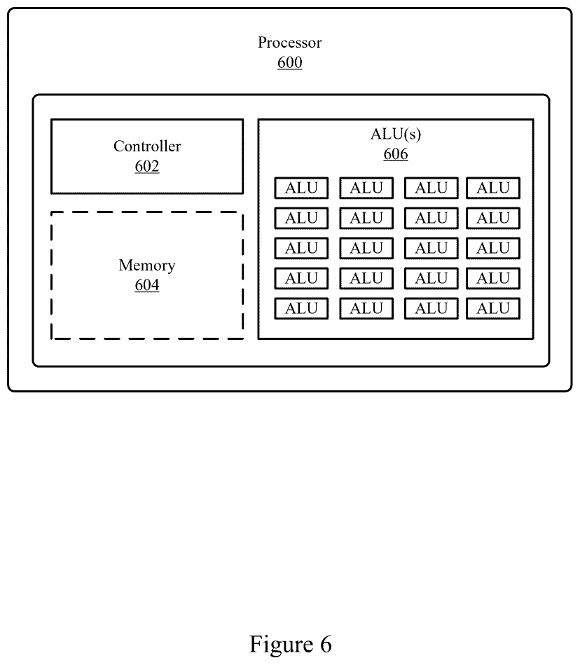

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory addresses of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, ALUs 606, and other functional units of the processor 600.

The memory 604 may include one or more caches (e.g., memory local to or included in the processor 600 or other memory, such as RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, and the controller 602, and may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 may be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. The processor 600 may be configured to or operable to support at least one controller (e.g., the controller 602) coupled with at least one memory (e.g., the memory 604) and configured to cause the processor to transmit, to a NE, a request for one or more SIB1 transmissions; and receive, from the NE, a first DCI in a format scrambled with a RNTI, the first DCI being determinable as an acknowledgement.

Additionally, the processor 600 may be configured to or operable to support any one or combination of the at least one controller is configured to cause the processor to stop a SIB1 transmission request procedure based on the first DCI in the format scrambled with the RNTI determined as the acknowledgement. The RNTI is at least one of a RA-RNTI, a MsgB-RNTI, a SI-RNTI, or a SIB1-RNTI. The at least one controller is configured to cause the processor to detect a SIB1 transmission based on detection of the first DCI. To detect the SIB1 transmission, the format scrambled with a SI-RNTI configures the at least one controller to cause the processor to detect a second DCI. The SIB1 transmission is scheduled according to the first DCI. The SIB1 transmission is scheduled according to a PDSCH that is scheduled by the first DCI. The at least one controller is configured to cause the processor to restart a SIB1 transmission request procedure based on the processor does not detect the first DCI as the acknowledgement.

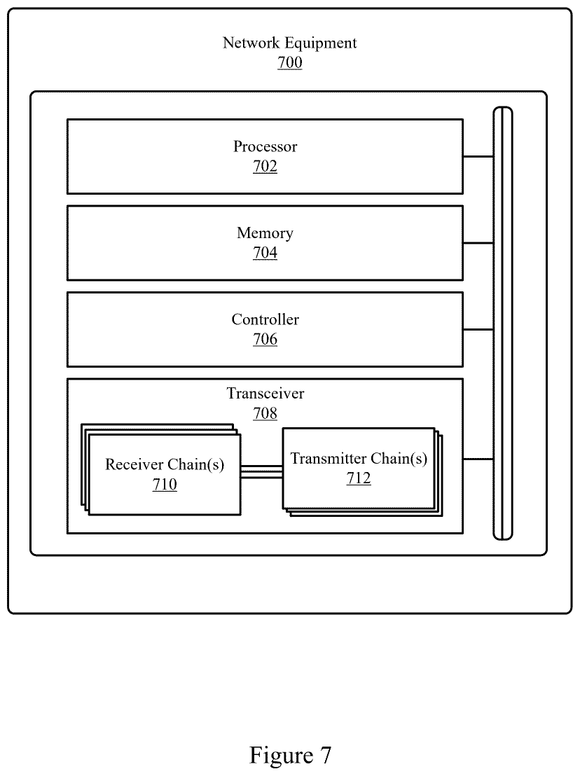

FIG. 7 illustrates an example of an NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704). For example, the processor 702 may support wireless communication at the NE 700 in accordance with examples as disclosed herein. The NE 700 may be configured to or operable to support a means for receiving, from a UE, a request for one or more SIB1 transmissions; and transmitting, to the UE, a first DCI in a format scrambled with a RNTI, the first DCI being determinable by the UE as an acknowledgement.

Additionally, the NE 700 may be configured to or operable to support any one or combination of the RNTI is at least one of a RA-RNTI, a MsgB-RNTI, a SI-RNTI, or a SIB1-RNTI. The method further comprising receiving an additional request for the one or more SIB1 transmissions based on the UE does not detect the first DCI as the acknowledgement.

Additionally, or alternatively, the NE 700 may support at least one memory (e.g., the memory 704) and at least one processor (e.g., the processor 702) coupled with the at least one memory and configured to cause the NE to receive, from a UE, a request for one or more SIB1 transmissions; and transmit, to the UE, a first DCI in a format scrambled with a RNTI, the first DCI being determinable by the UE as an acknowledgement.

Additionally, the NE 700 may be configured to support any one or combination of the RNTI is at least one of a RA-RNTI, a MsgB-RNTI, a SI-RNTI, or a SIB1-RNTI. The at least one processor is configured to cause the NE to receive an additional request for the one or more SIB1 transmissions based on the UE does not detect the first DCI as the acknowledgement.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

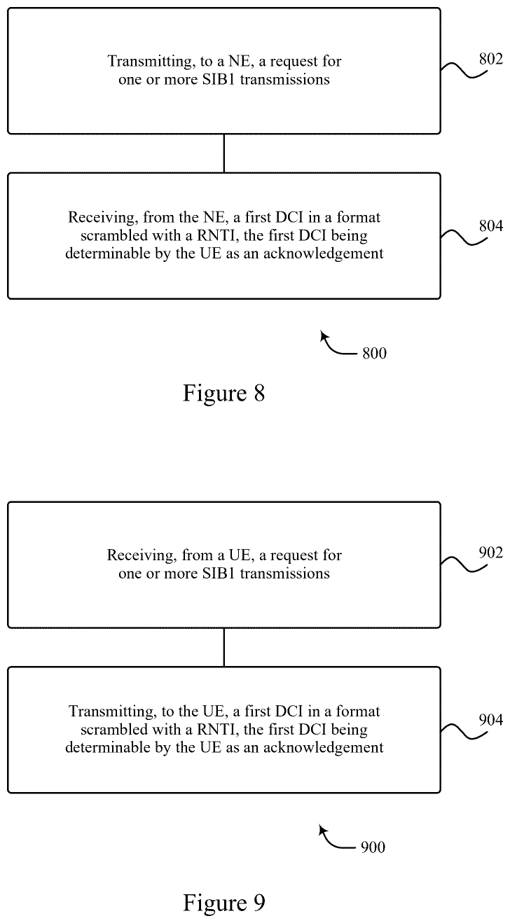

FIG. 8 illustrates a flowchart of a method 800 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 802, the method may include transmitting, to a NE, a request for one or more SIB1 transmissions. The operations of 802 may be performed in accordance with examples as described herein. In some implementations, aspects of the operations of 802 may be performed by a UE as described with reference to FIG. 5.

At 804, the method may include receiving, from the NE, a first DCI in a format scrambled with a RNTI, the first DCI being determinable by the UE as an acknowledgement. The operations of 804 may be performed in accordance with examples as described herein. In some implementations, aspects of the operations of 804 may be performed by a UE as described with reference to FIG. 5.

FIG. 9 illustrates a flowchart of a method 900 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 902, the method may include receiving, from a UE, a request for one or more SIB1 transmissions. The operations of 902 may be performed in accordance with examples as described herein. In some implementations, aspects of the operations of 902 may be performed by an NE as described with reference to FIG. 7.

At 904, the method may include transmitting, to the UE, a first DCI in a format scrambled with a RNTI, the first DCI being determinable by the UE as an acknowledgement. The operations of 904 may be performed in accordance with examples as described herein. In some implementations, aspects of the operations of 904 may be performed by an NE as described with reference to FIG. 7.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
transmit, to a network equipment (NE), a request for one or more system information block 1 (SIB1) transmissions; and
receive, from the NE, a first downlink control information (DCI) in a format scrambled with a radio network temporary identifier (RNTI), the first DCI being determinable by the UE as an acknowledgement.

2. The UE of claim 1, wherein the at least one processor is operable to cause the UE to stop a SIB1 transmission request procedure based at least in part on the first DCI in the format scrambled with the RNTI determined as the acknowledgement.

3. The UE of claim 1, wherein the RNTI is at least one of a random access (RA)-RNTI, a message B (MsgB)-RNTI, a system information (SI)-RNTI, or a SIB1-RNTI.

4. The UE of claim 1, wherein the at least one processor is operable to cause the UE to detect a SIB1 transmission based at least in part on detection of the first DCI.

5. The UE of claim 4, wherein, to detect the SIB1 transmission, the format scrambled with a system information (SI)-RNTI configures the at least one processor to cause the UE to detect a second DCI.

6. The UE of claim 4, wherein the SIB1 transmission is scheduled according to the first DCI.

7. The UE of claim 4, wherein the SIB1 transmission is scheduled according to a physical downlink shared channel (PDSCH) that is scheduled by the first DCI.

8. The UE of claim 1, wherein the at least one processor is operable to cause the UE to restart a SIB1 transmission request procedure based at least in part on the UE does not detect the first DCI as the acknowledgement.

9. A method performed by a user equipment (UE), the method comprising:
transmitting, to a network equipment (NE), a request for one or more system information block 1 (SIB1) transmissions; and
receiving, from the NE, a first downlink control information (DCI) in a format scrambled with a radio network temporary identifier (RNTI), the first DCI being determinable by the UE as an acknowledgement.

10. The method of claim 9, further comprising stopping a SIB1 transmission request procedure based at least in part on the first DCI in the format scrambled with the RNTI determined as the acknowledgement.

11. The method of claim 9, wherein the RNTI is at least one of a random access (RA)-RNTI, a message B (MsgB)-RNTI, a system information (SI)-RNTI, or a SIB1-RNTI.

12. The method of claim 9, further comprising detecting a SIB1 transmission based at least in part on detection of the first DCI.

13. The method of claim 12, wherein, to detect the SIB1 transmission, the format scrambled with a system information (SI)-RNTI configures the UE to detect a second DCI.

14. The method of claim 12, wherein the SIB1 transmission is scheduled according to the first DCI.

15. The method of claim 12, wherein the SIB1 transmission is scheduled according to a physical downlink shared channel (PDSCH) that is scheduled by the first DCI.

16. The method of claim 9, further comprising restarting a SIB1 transmission request procedure based at least in part on the UE does not detect the first DCI as the acknowledgement.

17. A network equipment (NE) for wireless communication, comprising:
at least one memory; and
at least one processor coupled with the at least one memory and operable to cause the NE to:
receive, from a user equipment (UE), a request for one or more system information block 1 (SIB1) transmissions; and
transmit, to the UE, a first downlink control information (DCI) in a format scrambled with a radio network temporary identifier (RNTI), the first DCI being determinable by the UE as an acknowledgement.

18. The NE of claim 17, wherein the RNTI is at least one of a random access (RA)-RNTI, a message B (MsgB)-RNTI, a system information (SI)-RNTI, or a SIB1-RNTI.

19. A method performed by a network equipment (NE), the method comprising:
receiving, from a user equipment (UE), a request for one or more system information block 1 (SIB1) transmissions; and
transmitting, to the UE, a first downlink control information (DCI) in a format scrambled with a radio network temporary identifier (RNTI), the first DCI being determinable by the UE as an acknowledgement.

20. The method of claim 19, wherein the RNTI is at least one of a random access (RA)-RNTI, a message B (MsgB)-RNTI, a system information (SI)-RNTI, or a SIB1-RNTI.
